(19) United States
(12) Patent Application Publication
(10) Pub. No.: US 2011/0008753 A1
(43) Pub. Date: Jan. 13, 2011

(54) TOOTH IMPLANT AND METHOD FOR PRODUCTION THEREOF

(76) Inventors: Bernd Rupprecht, Leinefelde-Worbis OT Beuren (DE); Axel Cyron, Salzgitter (DE)

Correspondence Address: PATENT CENTRAL LLC;Stephan A. Pendorf, 1401 Hollywood Boulevard, Hollywood, FL, 33020, US

(21) Appl. No.: 12/919,766

(22) PCT Filed: Feb. 2, 2009
(86) PCT No.: PCT/EP09/00663

§ 371 Date: Aug. 27, 2010

(30) Foreign Application Priority Data
Feb. 29, 2008 (DE) 10 2008 011 963.6

(51) Int. Cl. A61C 8/00

(52) U.S. Cl. 433/173; 433/201.1

(57) ABSTRACT

A dental implant, comprising a base (10) areas of which can be inserted into a jawbone, having an apically located body (12) and a coronally located neck (14) whose outer surfaces each have a surface microstructure of given roughness, the value of the mean roughness of the body surface being larger than the value of the mean roughness of the neck surface, with the value of the mean roughness of the body surface being Ra=0.75 to 0.95 micrometers and the value of the mean roughness of the neck surface being Ra=0.55 to 0.71 micrometres.

### FIELD OF THE INVENTION

The invention relates to a dental implant, comprising a base that can be inserted sectionally into a jawbone, said base having an apically located body and a coronally positioned neck, the outer surfaces of which in each case have a surface microstructure of predetermined roughness, wherein the mean roughness value of the body surface is greater than the mean roughness value of the neck surface.

The invention further relates to a method of producing a dental implant base.

### STATE OF THE ART

Such dental implants are known from DE 60 2004 007 427 T2 (German translation of EP 1 477 141 B1).

Enossal dental implants have long been known and in the course of their development a wide range of variants and different terminologies to describe such implants have come into use. In the case of the present application, the following terminology will be used both for describing the state of the art and also for explaining the invention: the dental implant always comprises a base that can be inserted, at least in certain places, into the jawbone. In the case of the dental implants which are the subject of the present invention, the base can be divided into two axial areas. A first area, called the body, is substantially completely inserted in its final intended position into the jawbone. A coronally adjoining second area, called the neck, projects in its final intended position substantially completely above the jawbone and is surrounded by gingival tissue. Coronally from the base there is typically arranged an adjoining abutment that projects substantially completely above the gingival tissue. The abutment serves as the core of a crown that is attached thereto. The abutment can be of one piece with the base, or it may be formed as a separate component that is, for example, screwed to or bonded with the base.

In order to mechanically pre-fix the base in the jawbone, the outer surface of the body is often provided with a possibly self-cutting thread by means of which the base is screwed into a pre-drilled recess in the jawbone. However, permanent fixation of the implant depends substantially on the interaction that goes beyond this prefixing measure and takes place between the biological material, i.e. the bone and/or gingival tissue, and the surface of the implant base. The biocompatibility of the base material is an important first factor. Bases made of titanium or titanium alloys have proved effective in this case. However, the surface structure of the implant base also plays a very important role in achieving optimal interaction between the tissue and the material of the base. Many studies have been and still are being carried out on this topic, sometimes with contradictory results. There is general agreement that microstructuring of the surface can have positive effects.

DE 695 33 448 T2 (German translation of EP 0 794 745 B1) proposes creating a uniform surface roughness for the body and the neck of the implant base. On the other hand, the generic patent DE 60 2004 007 427 T2 takes into account the various properties of bone tissue and gingival tissue and consequently proposes using different surface roughnesses for the body area and for the neck area of the base. In particular, it is proposed that the surface roughness of the body should be adjusted to one to three micrometres by means of an etching process, whereas the surface of the neck should be given a “relatively smooth” finish. This results in a sharp demarcation between the surface roughnesses of the body and of the neck, and the roughness of the body surface should be optimized for the interaction with the bone tissue, while the surface roughness of the neck should be optimized for the interaction with the gingival tissue. These known types of implant have the disadvantage that, in the inserted state, the roughness boundary usually does not coincide, or at least not over the full circumference, with the boundary between the tissues of the bone and the gingiva. This has less to do with imprecise insertion of the implant than with the natural shape of the alveolar crest in the jaw, a fact which, typically, does not permit a recess to be produced with a perfectly horizontal edge that would match the roughness boundary. As a result, there are intermediate areas in which tissue material must interact with a surface having a surface roughness that is completely unsuited for this interaction.

### STATEMENT OF THE TASK

The task of the present invention is to further develop generic dental implants in such a way that better tissue bonding occurs in particular in the transition zone between bone and gingival tissue.

### DESCRIPTION OF THE INVENTION

This task is solved, in conjunction with the features of the preamble to claim 1, by the mean roughness of the body surface having a value of Ra=0.75 to 0.95 micrometres, and by the mean roughness of the neck surface having a value of Ra=0.55 to 0.71 micrometres.

The roughness values proposed in accordance with the invention are the result of an extensive, experimentally verified trade-off between, on the one hand, optimizing each surface to interact with the type of tissue respectively assigned to it and, on the other hand, ensuring the compatibility of the surface with the respective other type of tissue. Surprisingly, this suboptimal configuration of each area of the surface with regard to the respectively assigned tissue leads, overall, to improved durability of the implant, because the resulting significantly improved interaction in the critical transition zone between bone and gingiva has an over-compensating effect. It appears as if, in the case of state-of-the-art implants, the incompatibilities between surfaces optimized for one type of tissue, on the one hand, and the respective other type of tissue, on the other hand, have been exerting so far completely underestimated negative effects on the overall durability of the implant. However, there are no corresponding reports available on the matter. The invention is the result of a more holistic approach which has so far not been pursued anywhere else.

Another advantage of the invention is that it offers greater variability in the use of the inventive implant. Thanks to the improved compatibility of the surface properties of the various areas with regard to the respective other tissue type, as explained above, it is possible, when inserting the implant, to vary the insertion depth as required, without compromising the durability of the implant. In contrast, in the case of state-of-the-art implants, if it becomes necessary during the operation to use a different insertion depth from the one intended, another appropriately dimensioned implant would have to be selected. It would not be possible to vary the insertion depth of a given implant.

Particularly advantageous embodiments of the invention are the subject of the dependent claims.

In principle, the roughness values according to the invention can be obtained in any desired way. However, it has proved efficient to create the surface microstructure of the body surface by carrying out abrasive blasting, using a hard abrasive such as sand or corundum, followed by an etching process, and to create the surface microstructure of the neck surface by carrying out an etching process. The etching is performed preferably using an alkaline etching agent, especially an etching agent having a high concentration of potassium hydroxide. An etching process of this kind is known from DE 603 01 796 T2 (German translation of EP 1 515 759 B1), which however is otherwise concerned with the multi-layered structure of a dental implant base.

Because of the proven biocompatibility, the base preferably consists substantially of metal or of a metal alloy, in particular titanium or a titanium alloy.

In order to achieve a purely mechanical pre-fixing of the implant in the jawbone, the body is preferably provided with a macroscopic external thread structure. As is known from the state of the art, this structure can then be screwed into a prepared recess in the jawbone to provide positive mechanical fixing of the base that allows the tissue to bond with the surface of the base that has been configured according to the invention. Self-cutting thread structures are advantageous in this case.

The neck preferably possesses a circumferential annular groove. Advantageously, the annular groove is of circular-segment shape in cross section and has a radius of 0.2 to 0.3 millimetres, in particular of approximately 2.5 millimetres. Such an annular groove improves the bonding of desired tissue with the surface of the base. One frequent problem relating to the tissue bonding involves rapidly growing epithelial cells that grow along the surface of the base in the coronal to apical direction and thus impede or prevent the bonding of gingival tissue with the neck of the base or, in the case of extensive epithelial cell growth, such cells also impede or prevent the bonding of bone cells with the surface of the implant body. However, it has been found that sharp edges, such as those presented for example by the margins of an annular groove of preferably approximately semicircular cross section, prevent the undesired growth of epithelial cells. Thus, the slower-growing gingival or connective tissue cells gain sufficient time to bond with the base in the neck area, before the epithelial cells overgrow this area. This also means that there is no longer any danger that areas located further away in an apical direction will be overgrown by the epithelial cells, so that the even more slowly growing bone cells have enough time to bond with the body area of the base. An additional effect of the advantageous annular groove is that the interaction surface is enlarged compared to a substantially cylindrical neck of the base. As a result, the overall force with which the implant is held in the tissue is increased. Finally, the connective tissue that grows into the annular groove forms a seal like that of an O-ring that offers good protection against the penetration of undesired contaminant particles. It should be noted that the provision of the annular groove is not necessarily linked with the distribution of surface roughness according to the invention. Rather, it is possible by means of the described annular groove to substantially improve also implants that have other distributions of roughness on the surface of their base.

One important problem zone on dental implants is the transition from the base to the abutment. Typically, the base is substantially hollow and has an insertion area for a corresponding connection area on the abutment. The connection between the abutment and the base is frequently made by a screw that passes through the abutment and is screwed into an internal thread on the base. This inevitably leaves cavities remaining in the interior of the base. It is particularly important that these cavities should be sealed shut in a gas-tight and bacteria-tight manner. One critical zone in this regard is the contact zone between the receiving opening of the base and the insertion area of the abutment. Therefore, in order to improve gas tightness and bacteria tightness in a further development of the invention, an abutment is provided that can be inserted by means of a conical connecting area into a receiving area of the internally hollow base, the conical connecting area having an outer surface running conically in the apical direction with an abutment taper angle, the receiving area in the coronal area of the neck having an inner surface running conically in the apical direction from the opening angle of the base, and the abutment taper angle being larger by 20 to 60 minutes of arc than the base opening angle. The absolute value of the base opening angle or of the abutment taper angle is preferentially 15 to 25 degrees, preferably approximately 20 degrees. The abutment taper angle is therefore slightly more obtuse than the base opening angle. This results in a sharp, annular contact zone between the conical connecting area of the abutment and the receiving opening of the base. When both elements are screwed together, the small area of the contact zones results in a high pressure that generates very good gas tightness and bacteria tightness. It should be noted that this type of tight connection is the reverse of the so-called ground glass cover principle in which the taper angle of a stopper to be inserted is slightly more acute than the angle of the corresponding receiving opening, and the closing effect of this type of design is based on the especially large surface of the interaction zone. It should also be noted that the advantageous seal described between the base and the abutment does not necessarily have to be linked with the distribution of the surface roughnesses of the base according to the invention. Rather, this type of seal is entirely suitable also for improving the gas and bacteria tightness of multi-part dental implants having a differently structured surface of the base component.

Titanium, titanium alloys and zirconium oxide have proved suitable as the main materials for the abutment. One significant problem in the case of two-part dental implants is how to prevent the abutment from rotating relative to the base, on the one hand, and how to achieve precise alignment of the abutment relative to the base, on the other hand.

In an advantageous further development of the invention it is therefore provided that the abutment has a non-rotation-symmetrical anti-rotation projection located apically from the conical connection area, and said projection can be inserted with a positive fit into a corresponding anti-rotation recess in the base. The anti-rotation projection and the corresponding anti-rotation recess have preferably axially oriented walls. Because of the lack of rotational symmetry, the anti-rotation effect is achieved by positive engagement of the projection in the recess. In order to achieve good alignability, it may additionally be provided that the anti-rotation projection and the corresponding anti-rotation recess are designed with multiple axial or multiple rotation-inversion symmetry. The first case occurs, for example, when uniform, even-numbered polygonal or star shapes are used, while the second case occurs for example when uniform, odd-numbered polygonal or star shapes are used as the profile of the anti-rotation projection and of the anti-rotation recess. Such anti-rotation measures are in principle known from DE 600 022 35 T2. In order to improve alignability, a high-order symmetry should be achieved. Preference is given to 12-fold polygonal, star or clover-leaf shapes.

However, in some cases the alignment of the abutment and the base relative to each other plays no role at all, or only a subordinate one. In such cases provision can be made that the design comprises an abutment that adjoins the neck coronally and is connected in one piece with the base. The bonded connection can be produced for example by using a cement-like adhesive or by welding. These variants, especially the one-piece configuration, guarantee optimum gas and bacteria tightness.

Bonded connections of the abutment and the base are also possible in which the bonding, on a case-by-case basis, is carried out before or after insertion of the base.

Further features and advantages of the invention can be seen from the specific description and the drawings, which now follow.

### BRIEF DESCRIPTION OF THE DRAWINGS

The drawings show:

FIG. 1: a cross-sectional view of a first embodiment of a dental implant base according to the invention

FIG. 2: a lateral view of the base shown in FIG. 1

FIG. 3: a top view of the base shown in FIG. 1

FIG. 4: a view from below of the base shown in FIG. 2

FIG. 5: a cross-sectional view of a second embodiment of a dental implant base according to the invention

FIG. 6: a lateral view of the base shown in FIG. 5

FIG. 7: a cross sectional view of the base shown in FIG. 1 with a first embodiment of an inserted abutment

FIG. 8: a cross sectional view of a base with a second embodiment of an abutment connected by bonding

FIG. 9: a lateral view of a third embodiment of an abutment

FIG. 10: a partially cross-sectional and cutaway lateral view of the base shown in FIG. 9

FIG. 11: a lateral view of a fourth embodiment of an abutment

FIG. 12: a partially cross-sectional and cutaway view of the abutment shown in FIG. 11

FIG. 13: a one-piece embodiment of an implant according to the invention

FIG. 14: a diagrammatic view of a natural row of teeth

FIG. 15: a diagrammatic view of a row of teeth with an implant according to the state of the art

FIG. 16: a diagrammatic view of a row of teeth with an implant according to the invention.

### DETAILED DESCRIPTION OF PREFERRED EMBODIMENTS

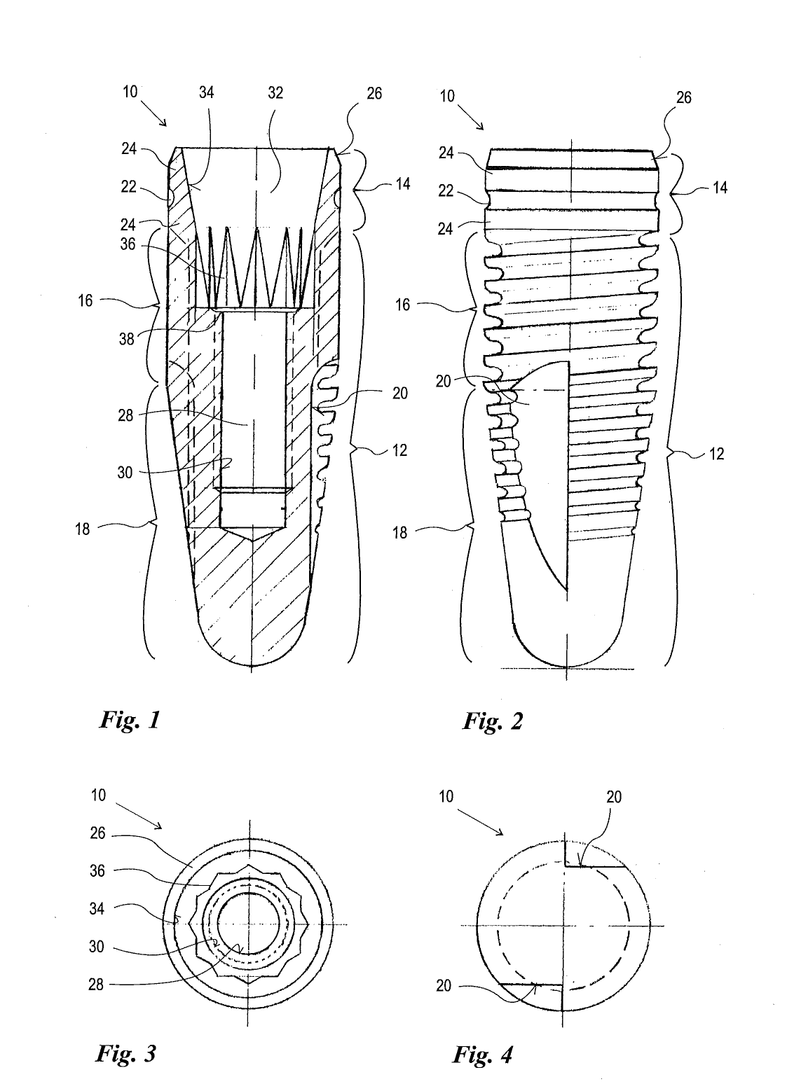

FIGS. 1 to 4 show various views of a preferred embodiment of an implant base 10 according to the invention. The base 10 comprises an apically situated body 12 and a neck 14 coronally adjoining thereto. In the implanted state (see FIG. 16) the body 12 is substantially surrounded by bone tissue while the neck 14 is substantially surrounded by new gingival tissue. In the preferred embodiment, the base body 12 is divided into two sections, namely a coronally located, substantially cylindrical section 16 and, apically located therefrom, a conically tapering section 18 that ends in a radius. Both sections 16 and 18 carry a multi-start macroscopic external thread whose depth becomes reduced and runs out to zero in the direction of the taper point in the conical section 18. The purpose of the thread is to mechanically pre-fix the base in a recess drilled in the jawbone before the base is inserted. The thread is preferably of the self-cutting type so that the base can be screwed into a recess in the bone having straight borehole walls.

The embodiment shown has an axially extending cutting edge 20 at right angles with the radial direction, the cutting depth corresponding approximately to the depth of the thread. The cutting edge 20 extends over the entire thread-bearing part of the conical section 18 and projects coronally slightly beyond this into the cylindrical section 16. A cutting edge 20 of this type, which does not have the macroscopic thread structure, has proved to be an advantageous interaction surface with the bone tissue and improves the bonding of the tissue with the implant, so that a more solid anchoring of the base 10 in the jawbone is achieved. In order to increase this effect, the embodiment shown has two such cutting edges 20 arranged symmetrically opposite each other relative to the centre point of the transverse plane of the base. In other embodiments, which are not shown here, more or fewer than two cutting edges 20 may be provided. Also, the right-angled configuration of the cutting edges 20 is not strictly necessary, although it is advantageous from a manufacturing standpoint. Compared to a cutting edge running along a continuous chord of a circle (relative to the cross section), which in principle is also possible, the angled configuration of the cutting edge 20 has the advantage that it secures the implant more efficiently against rotational and translational forces acting on the embedded base 10.

The neck 14 of the depicted embodiment of the implant base 10 is substantially cylindrical in shape in its apical section and has an annular groove 22 that interrupts the cylindrical surface. In the depicted embodiment the cylindrical areas 24 of the neck 14 adjacent to the annular groove 22 are approximately of equal width, and this width in turn corresponds approximately to the width of the annular groove 22. As mentioned, in the embedded state, the neck 14 is substantially surrounded by gingival tissue. The gingival tissue grows also in particular into the annular groove 22 and forms an effective seal in the manner of an O-ring. Furthermore, the edges of the annular groove 22, at the transitions to the cylindrical areas 24, inhibit the growth of epithelial cells that typically can grow very quickly in a coronal to apical direction along the outer wall of the base 10 and may impede the bonding process of slower growing gingival tissue cells in the area of the neck 14 and possibly of bone tissue cells in the area of the body 12.

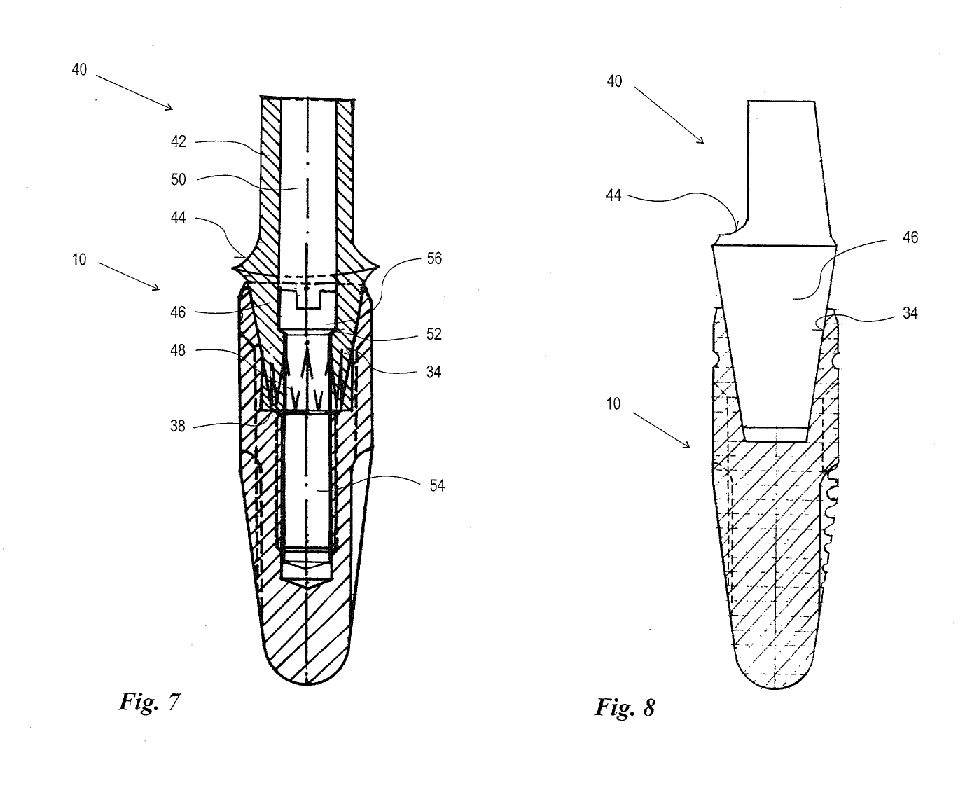

At the coronal end of the neck 14 there is a bevel 26 that narrows the coronal end zone of the neck 14. This allows for a better fit of the contour with an abutment that is fitted on the base and that will be described further below in conjunction with FIG. 7.

The interior of the base 10 is substantially hollow, as can be seen in particular from the cross-sectional view in FIG. 1. The apical area of the inner recess of the base 10 takes the form of a blind borehole 28 with an internal thread 30. The purpose of this internal thread 30 is to permit fixation of the abutment by means of a screw, as will be described further below in connection with FIG. 7. The blind borehole 28 is adjoined coronally by a receiving area 32 for the abutment, said receiving area 32 being divided into two sections. A coronal section 34, which acts as the insertion area for the abutment, is configured substantially as an apically oriented hollow cone, while the apically located section 36, which provides rotation prevention for the abutment, has a straight wall bearing the projections that are continuations of the surface of the hollow cone. The resulting non-rotation-symmetrical structure, which in the embodiment shown has the form of a 12-pointed star, can easily be recognized in the top view depicted in FIG. 3. As will be described in more detail further below in connection with FIG. 7, the purpose of this structure is to prevent rotation of the abutment. Even at its narrowest point, i.e. its apical boundary, the receiving area 32 is wider than the adjacent blind borehole 28 so that a shoulder 38 is formed. This shoulder 38 acts as a stop surface for the abutment, which will be described further below.

The macroscopic surface structure of the base 10, which can be seen in FIGS. 1 and 2, is overlain by a microstructure that is not visible in the Figures and that, in principle, can be advantageously used also independently of the macroscopic structure. This microstructure can be characterized in particular according to its roughness values. For such characterization, it is possible in particular to use the so-called Ra-value according to DIN EN ISO 4287, which corresponds to the arithmetic mean roughness value. In a particularly preferred embodiment, the Ra-value, measured linearly over 2000 micrometres in the area of the neck 14 is Ra=0.68±0.02 micrometres and in the area of the body Ra=0.90±0.03 micrometres. Measured over a length of 800 micrometres, the readings obtained on the same implant base in the area of the neck were Ra=0.61±0.03 micrometres and in the area of the body Ra =0.79±0.03 micrometres. Measurement over an area having the dimensions 100×100 micrometres, using an AFM (atomic force microscope) on the same measurement object, gave an Sa-value of Sa=0.451±0.023 micrometres in the area of the neck and Sa=0.598±0.031 micrometres in the area of the body.

In order to produce such roughness values, proceeding from a ground or polished surface having the desired macrostructure, the body 12 of the base 10 is blasted with a hard blasting agent of suitable size, such as sand, glass beads or corundum, until an Ra-value that is larger than the finally desired Ra-value is achieved. This temporary roughness value can in particular assume a magnitude of Ra=0.85 to 1.20. In the case of the example described further above, the temporary Ra-value measured linearly over 2000 micrometres was Ra=1.13±0.04 micrometres and when linearly measured over 800 micrometres, the value was Ra=0.89±0.02 micrometres. The corresponding Sa-value measured over an area of 100×100 micrometres was Sa=0.705±0.033 micrometres. In a subsequent processing step, the entire base 10 undergoes alkaline etching using an alkaline etchant containing a high concentration of potassium hydroxide as is in principle known from DE 603 01 796 T2. The etching is carried out until the surfaces of the neck 14 and of the body 12 of the base 10 have attained the desired roughness values.

In an actual manufacturing process, a machined neck of an implant and a corundum-blasted body is treated with 1 mol/L NaOH+2% H₂O₂ at 80° C. for 10 minutes followed by acid etching at 98° C. for 1 hour. This creates a roughness gradient from the neck of the implant to the body of the implant with a difference in roughness of Ra=0.18 micrometres. The difference in roughness between the neck and the body permits selective bonding of fibroblasts in the neck area and of osteoblasts in the body area. At the same time, the surface of the neck also exhibits good osteogenic properties, so that good bonding of the osteoblasts can occur in the area of the bone/gingiva transition, even if the bone level is not straight. This is not possible if the neck surfaces are smooth. The inventors proceed from the assumption that the roughness of the neck increases the initial hydrophilia of the implant surface and this can be expected to produce better wetting of the material surface by blood components. This results in a very high initial adhesion rate for fibroblasts and osteoblasts. This fact was demonstrated in vitro after fibroblasts and osteoblasts had been incubated for a period of four hours. Because of these properties, a bacteria-tight seal is formed in the neck area during the first phase of wound healing. Smooth surfaces possess this property only to a very limited extent. The resulting reduced adhesion of desired cell types can lead to an increased growth rate in epithelial cells, which then form a long junctional epithelium along the neck as far as the transition between the neck and the body. This area is then sensitive to bacterial invasion (perimplantitis). Prevention of deep epithelial growth by a firm collar of connective tissue in the neck area, such as is made possible by the configuration of the neck and body surfaces according to the invention, prevents bone breakthrough.

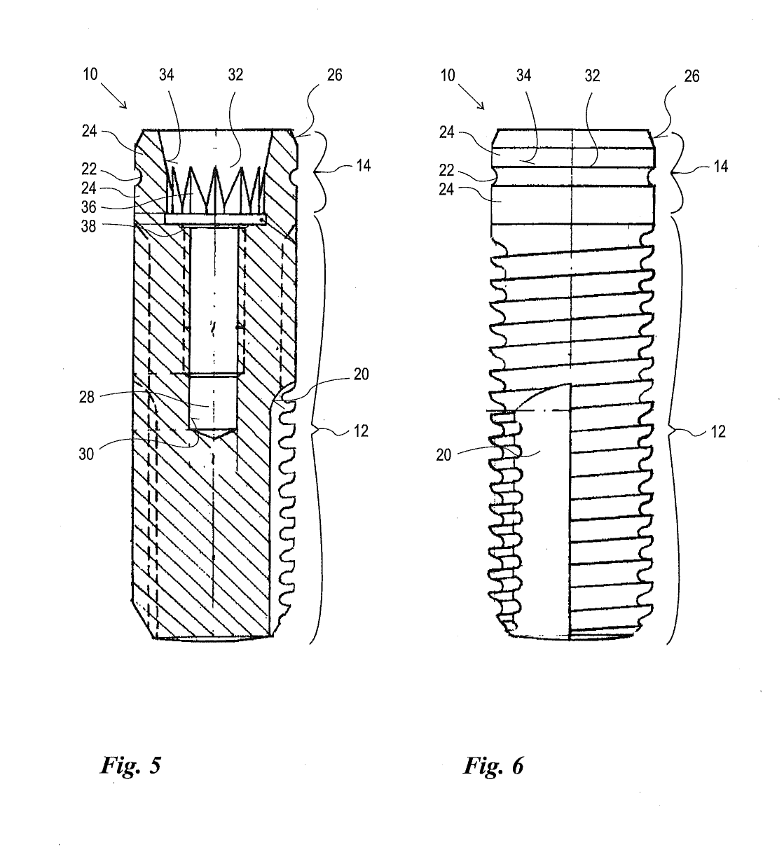

FIGS. 5 and 6 are different views of a second exemplary embodiment of a base 10 according to the invention. In contrast to the base 10 shown in FIGS. 1 and 2, the entire body 12 is substantially cylindrical in shape and is provided with a continuous thread. In other respects, reference is made to the description for FIGS. 1 to 4, whose reference nos. have been taken over into FIGS. 5 and 6. FIG. 7 shows the base 10, as seen in FIGS. 1 and 2, with an inserted abutment 40. The abutment 40 comprises a substantially hollow cylindrical coronal area 42, an apically adjoining support area 44, a connecting area 46 adjoining apically thereto, and an anti-rotation projection 48 forming the apical end of the abutment 40. Through the abutment 40 there passes a through-borehole 50 that in its coronal area is larger in diameter than in its apical area so that a shoulder 52 is formed. The connecting area 46 that tapers conically in an apical direction is designed to correspond to the conical insertion area 34 of the receiving space 32 of the base 10. The anti-rotation projection 48 is designed to correspond to the apical anti-rotation area 36 of the receiving area 32 of the base 10. The shoulder 38 in the base 10 forms a stop surface for the apical end surface of the anti-rotation projection 48. The abutment 40 can be inserted in a rotationally fixed manner into the base 10, with the conical insertion area 34 of the receiving space 32 of the base 10 acting as a centering aid. In order to fix the abutment 40 axially, a fixing screw 54 can be introduced into the through-borehole 50 and be screwed into the interior thread 30 of the base 10. The head 56 of the screw 54 is larger in diameter than the shaft of the screw and it rests against the shoulder 52.

As already mentioned, the conical connecting area 46 of the abutment 40 is matched to the conical insertion area 34 of the receiving space 32 of the base 10. In this regard, it is not strictly necessary for the taper angle of the conical connecting area 46 of the abutment 40 to match up exactly with the opening angle of the conical insertion area 34 of the receiving space 32 of the base 10. Rather, it is preferably provided that the taper angle of the abutment is 20-60 minutes of arc larger than the base opening angle so that a contact line, on which a large amount of pressure acts, is formed at the coronal margin of the base 10. This contact line forms a reliable seal against gas and bacteria. It should be noted that, in this case, the abutment 40 is not allowed to rest with its apical end surface against the shoulder 38 of the base 10. In this case, it is also advantageous if the non-rotation-symmetrical projections in the anti-rotation area 36 of the receiving space 32 of the base 10 have precisely axially aligned walls in order to guarantee a high degree of axial tolerance.

The support area 44 of the abutment 40 serves to support a crown, which is not shown in the Figures, that is attached to the abutment 40. In order to obtain a good adaptation of the abutment 40 to the crown, on the one hand, and also to achieve good bonding with the gingiva, on the other hand, the support area is preferably given a double concave configuration.

FIG. 8 shows an embodiment in which the abutment 40 is bonded with the base. In this case, no special measures are required to prevent rotation.

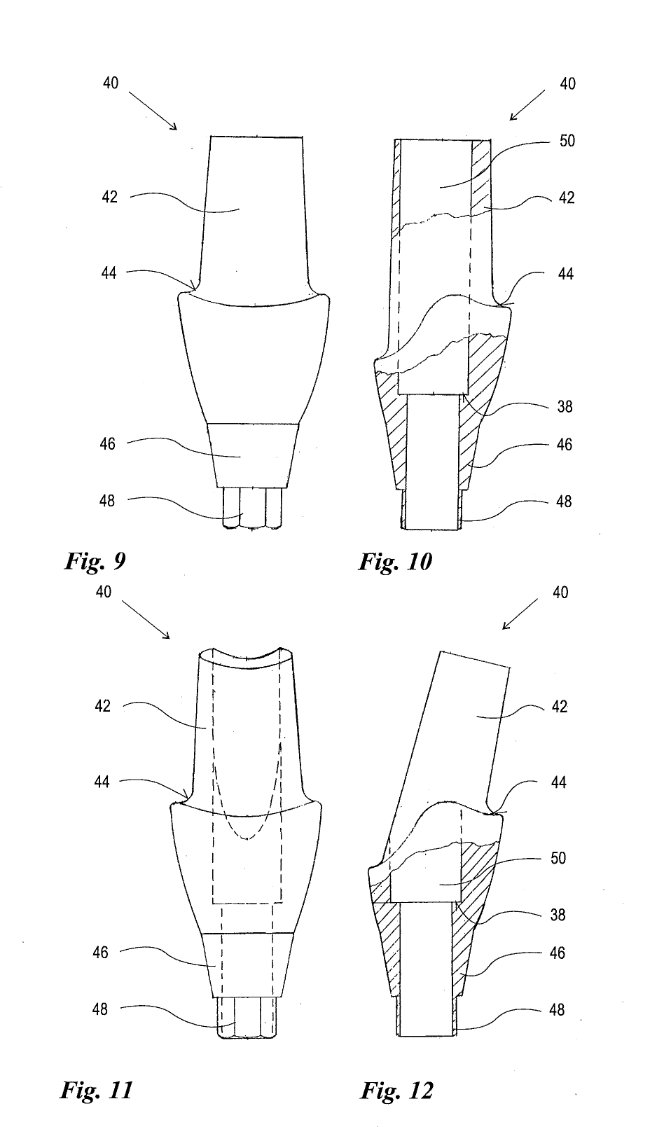

FIGS. 9 and 10 show two views of another embodiment of an abutment wherein the coronal area projecting above the base 10 in the assembled state has a more complex structure that is adapted to a specific dental geometry.

FIGS. 11 and 12 depict a further embodiment of an advantageous abutment 40 that is similar to the embodiment seen in FIGS. 9 and 10, but is intended for the case where an angle exists between the tooth crown and the artificial root that is formed by the implant base.

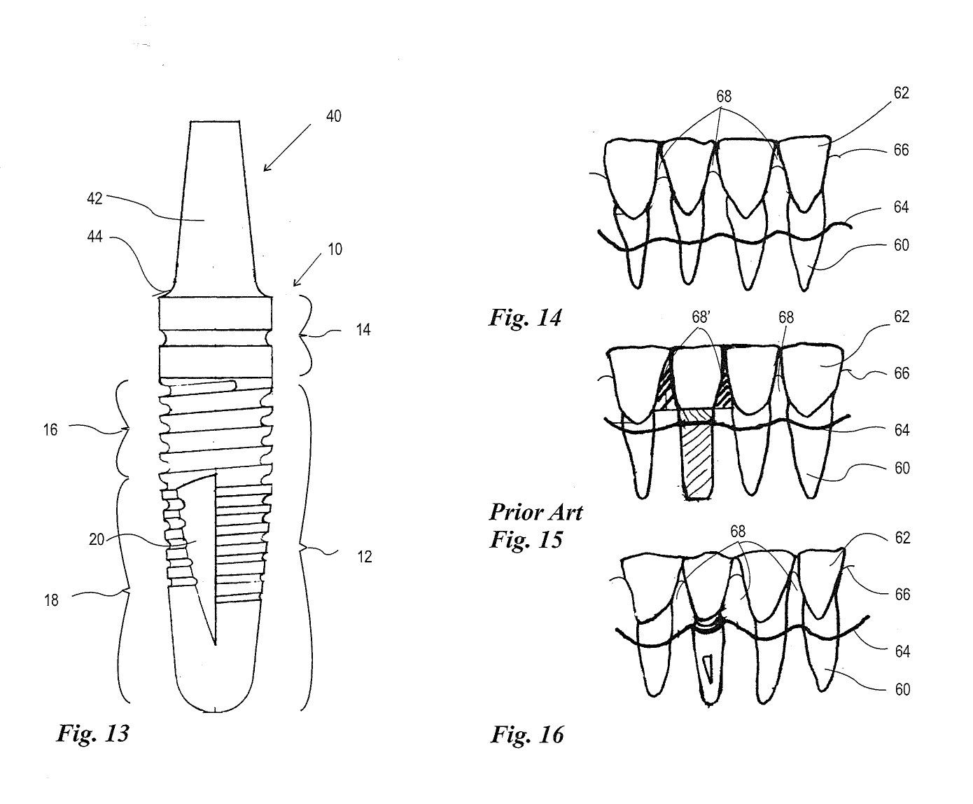

FIG. 13 shows a one-piece embodiment of an implant in which the base 10 and the abutment 40 are configured as one common component.

FIG. 14 shows in diagrammatic form the structure of a natural row of teeth having roots 60 and crowns 62, wherein the bone boundary 64 and the gingival boundary 66 are shown. It should be noted that in the case of healthy teeth the interdental papillae 68 project high into the interdental space. FIG. 15 shows diagrammatically a row of teeth with a state-of-the art implant. The frequently occurring problem is evident, namely that because of tissue bonding problems, the interdental papillae 68 have degenerated in the spaces between the neighbouring teeth of the implant.

FIG. 16 shows in diagrammatic form a row of teeth with an implant according to the invention. It should be noted that because of the improved tissue bonding the interdental papillae 68 have formed in the same way as in the case of natural teeth.

Of course, the embodiments discussed in the specific description and shown in the Figures are merely illustrative exemplary embodiments of the present invention. In the light of this disclosure the expert in the field is given a broad range of possible variations from which to choose. In particular, the individual aspects of the invention, namely the roughness distribution on the surfaces of the base body and the base neck, the specific geometric configuration of individual or multiple elements of the body, as well as the configuration of the abutment and its connection to the base may also be used independently of each other.

### LIST OF REFERENCE NUMBERS

10 Base

12 Body of 10

14 Neck of 10

16 Cylindrical section of 12

18 Conical section of 12

20 Cutting edge

22 Annular groove of 14

24 Cylindrical area of 14

26 Chamfer

28 Blind borehole

30 Internal thread

32 Receiving area

34 Insertion area of 32

36 Anti-rotation area of 32

38 Shoulder

40 Abutment

42 Coronal area of 40

44 Support area of 40

46 Connecting area of 40

48 Anti-rotation projection

50 Through-borehole

52 Shoulder

54 Fixing screw

56 Head of 54

1-14. (canceled)

15. A dental implant, comprising a base (10) that can be inserted sectionally into a jawbone, having an apically located body (12) and a coronally located neck (14) whose outer surfaces each have a surface microstructure of given roughness, the value of the mean roughness of the body surface being larger than the value of the mean roughness of the neck surface, which is less than Ra=1.1 micrometres, wherein the value of the mean roughness of the body surface is Ra=0.75 to 0.95 micrometers and the value of the mean roughness of the neck surface is Ra=0.55 to 0.71 micrometres.

16. A dental implant according to claim 15, wherein the surface microstructure of the body surface is produced by a blasting process using a hard blasting agent, followed by an etching process, and wherein the surface microstructure of the neck surface is produced by an etching process.

17. A dental implant according to claim 16, wherein the etching process comprises etching with an alkaline etchant.

18. A dental implant according to claim 17, wherein the etchant contains a high concentration of potassium hydroxide.

19. A dental implant according to claim 15, wherein the base (10) consists substantially of metal or of a metal alloy, in particular of titanium or a titanium alloy.

20. A dental implant according to claim 15, wherein the body (12) bears a macroscopic external thread structure.

21. A dental implant according to claim 15, wherein the neck (14) has a circumferential annular groove (22).

22. A dental implant according to claim 21, wherein the annular groove (22) has a circular-segment cross-section with a radius of from 0.2 to 0.3 millimetres, in particular of approximately 2.5 millimetres.

23. A dental implant according to claim 15, wherein it also comprises an abutment (40) that can be inserted by means of a conical connecting area (46) into a receiving area (32) of the internally hollow base (10), wherein the conical connecting area (46) has an outer surface running conically in the apical direction at an abutment taper angle, the receiving area (32) has an inner surface (34) running conically in the apical direction at a base opening angle, and the abutment taper angle is 20 to 60 minutes of arc larger than the base opening angle.

24. A dental implant according to claim 23, wherein the abutment (40) consists substantially of titanium, a titanium alloy or zirconium oxide.

25. A dental implant according to claim 23, wherein the abutment (40) is provided apically from the conical connecting area (46) with a non-rotation-symmetrical anti-rotation projection (48) that can be inserted with a positive fit into a corresponding anti-rotation recess (36) on the base (10).

26. A dental implant according to claim 15, further comprising an abutment (40) adjoining coronally at the neck (14), said abutment being of one piece with or bonded with the base.

27. A method for producing a dental implant base (10) having an apically situated body (12) and a coronally situated neck (14), comprising the following steps:
provision of a blank base element with ground or polished outer surfaces,
blasting of the outer surface of the body (12) using a hard blasting agent while simultaneously protecting the outer surface of the neck from the blasting agent,
etching the outer surfaces of the entire blank base element, so that the mean roughness value of the body surface is Ra=0.75 to 0.95 micrometres and the mean roughness value of the neck surface is Ra=0.55 to 0.71 micrometres.

28. A method according to claim 27, wherein the etching step comprises etching with an alkaline etchant, especially with a high concentration of potassium hydroxide.
